(19) United States
(12) Patent Application Publication
(10) Pub. No.: US 2008/0094325 A1
(43) Pub. Date: Apr. 24, 2008

(54) LIQUID CRYSTAL DISPLAY MODULE

(75) Inventors: Yong Beom KIM, Bupyeong-Gu (KR); Woon Yong Park, Paldal-Gu (KR); Kyu Yeol Kim, Wonmi-Gu (KR)

Correspondence Address: OBLON, SPIVAK, MCCLELLAND MAIER & NEUSTADT, P.C., 1940 DUKE STREET, ALEXANDRIA, VA, 22314, US

(73) Assignee: TOVIS Co. Ltd., Wonju-City (KR)

(21) Appl. No.: 11/551,056

(22) Filed: Oct. 19, 2006

(51) Int. Cl. G09G 3/36

(52) U.S. Cl. 345/87

(57) ABSTRACT

The present invention provides an LCD module, in which elements having high resistance to static electricity impact are used as circuit elements of a Printed Circuit Board (PCB) inside a Taped Carrier Package (TCP Board) connecting a front LCD panel to a rear main board, and static electricity introduced via the front LCD panel is dropped to a voltage that the main board can withstand when the static electricity is delivered to the main board, thereby having resistance to high voltage static electricity without requiring the formation or addition of a separate static electricity discharge path.

### BACKGROUND OF THE INVENTION

1. Field of the Invention

The present invention relates generally to a Liquid Crystal Display (LCD) module and, more particularly, to an LCD module, in which elements having high resistance to static electricity impact are used as circuit elements of a Printed Circuit Board (PCB) inside a Taped Carrier Package (TCP Board) connecting a front LCD panel to a rear main board, and static electricity introduced via the front LCD panel is dropped to a voltage that the main board can withstand when the static electricity is delivered to the main board, thereby having resistance to high voltage static electricity without requiring the formation or addition of a separate static electricity discharge path.

2. Description of the Related Art

Recently, with the rapid development of semiconductor technology in the semiconductor manufacturing industry, small-sized, light-weight LCD products having higher performance have been manufactured. Until now, Cathode Ray Tubes (CRT), widely used in information display devices, have many advantages in the light of performance and price, but disadvantages in the light of size and portability.

In contrast, LCDs have the advantages of small size, light weight and low power consumption, and, thus, has been emphasized as alternative means capable of overcoming the disadvantages of CRTs. Currently, LCDs are installed in almost all information processing apparatuses that require display devices.

Such an LCD applies voltage to the specific molecular arrangement of a liquid crystal, thereby transforming it into another molecular arrangement, and converts changes in the optical characteristics, such as birefringence, optical rotatory power, dichroism and a light scattering characteristic, of emitting liquid crystal cells into visible changes using the resulting molecular arrangement, and is a display device that modulates light based on the liquid crystal cells.

Recently, in order to accomplish slim design and light weight so as to ensure the competitiveness of related products, various types of structures have been developed. One of them is an LCD module that is manufactured by stacking backlight units, which are optical units, on a display panel in which an array substrate and a color filter substrate are attached to each other, inserting them into a support main frame and enclosing them in an upper casing and a lower casing.

Furthermore, a PCB, which applies signals to gate pads and data pads formed on the border of the display panel, is connected to the flexible cable through a TCP to which a drive Integrated Circuit (IC) is attached, and the flexible cable is connected to the rear surface of the support main frame.

FIG. 1 is a diagram illustrating the elements of a conventional LCD module.

As illustrated in FIG. 1, an LCD panel 5, in which an array substrate, including a plurality of pixels formed in a matrix arrangement, a color filter substrate, including R, G, and B color filters formed in a matrix arrangement, are attached to each other, and a backlight unit are stacked together, and then accommodated in a support main frame.

A gate PCB 7 for applying an operation signal is connected to the border of one side of the display panel 5 through a flexible cable between the gate pad of the display panel 5 and a gate TCP 6a.

Furthermore, in the gate TCP Ga, a gate drive IC for performing control so as to apply the operation signal to the display panel 5 using a specific scan method, is arranged in the flexible cable. Similarly, on the border of the other side of the display panel 5, a data PCB 9 for applying graphic signals is connected to the data pad of the display panel 5 via a flexible cable. A data TCP 6b for applying signals to the display panel 5 using the specific scan method is attached thereto.

Backlight units 10, each of which is composed of a plurality of optical sheets, a backlight 13 for generating light for representing images, a light guide plate 15 for converting light, generated by the backlight, into planar light having the size of the display panel 5, and a reflection plate 17 for reflecting light leaking from the light guide plate 15 and thus enhancing optical efficiency, are attached in a stacked arrangement below the display panel 5.

The backlight unit 10 and the display panel 5 are inserted into the support main frame 21 in a stacked arrangement so as to provide protection against external impact and optical alignment. Furthermore, in order to prevent the movement of the display panel 5, a panel guide 3 for tightening the display panel is attached thereto.

The support main frame 21 may be made of metallic material or plastic material. After the display panel 5 and the backlight unit 10 are inserted into the support main frame 21 in a stacked arrangement, the panel guide 3 is coupled to the support main frame 21. Thereafter, an upper casing 1 and a lower casing are attached to the support main frame 21 in which the display panel 5 and the backlight unit 10 are accommodated. Recently, only the upper casing 1 is attached to the support main frame 21 to achieve a slim shape.

In order to resolve a problem related to the grounds of the PCBs 7 and 9, which are folded and attached to the rear surface of the support main frame 21, that occurs due to the elimination of the lower casing as described above, a cover shield is attached to the support main frame 21, and the cover shield is electrically connected to the PCBs 7 and 9.

When the LCD module has been manufactured, the LCD module must undergo an Electric Static Discharge (ESD) test, as illustrated in FIG. 2.

The ESD test is a test for discharging static electricity of +/−12V about ten times for respective drive circuits, that is, a source drive circuit and a gate drive circuit. In general cases, the test conditions are normal, but, in the case of specific-purpose LCD modules, strict ESD test conditions have been proposed.

For example, in America, the LCD modules used in casinos (electronic game equipment) require performance for discharging static electricity of at least +/−20 KV due to the environment of occurrence of static electricity in casinos. For this purpose, the manufacturers of LCD modules attempt to produce products that satisfy requirements using various methods.

Representative examples include a method of rapidly conducting static electricity, applied from the outside, to a ground using a metal casing as entire housing, thereby protecting internal drive circuits, and a method of enclosing the circumference of the panel guide 3 with a copper foil and conducting static electricity, applied from the outside, to an external ground through the copper foil, thereby protecting internal drive circuits.

The above-described methods are mainly used for a measure for stabilizing internal circuits against relatively high static electricity. Substantially, the first method, that is, the method using a metal casing, has high stability and is the most reliable. However, this method has problems, such as increased cost and design limitation, due to the use of metal material for the entire housing, which are not related to the static electricity discharging performance.

Furthermore, the second method, that is, the method of implementing shielding using a copper foil, has advantages in that the manufacturing cost is reduced and design is freer, compared to the first method. However, this method has disadvantages in that static electricity-discharging performance is reduced somewhat and the wiring process is inconvenient because a lead line is required to connect the copper foil to an external ground, unlike the existing construction of circuits.

Furthermore, the second method, which is the method of implementing shielding using the copper foil, has a problem in that the copper foil, which is the construction for implementing shielding against static electricity, functions to stores static electricity charge, thereby acting as a source that generates higher static electricity when the lead line connecting the copper foil to an external ground is short-circuited, so that it may cause considerable damage to internal circuits and, thus, decrease reliability.

### SUMMARY OF THE INVENTION

Accordingly, the present invention has been made keeping in mind the above problems occurring in the prior art, and an object of the present invention is to provide an LCD module, in which elements having high resistance to static electricity impact are used as circuit elements of a Printed Circuit Board (PCB) inside a Taped Carrier Package (TCP Board) connecting a front LCD panel to a rear main board, and static electricity introduced via the front LCD panel is dropped to a voltage that the main board can withstand when the static electricity is delivered to the main board, thereby having resistance to high voltage static electricity without requiring the formation or addition of a separate static electricity discharge path.

In order to accomplish the above object, the present invention provides an LCD module including a display panel of an LCD, a support main frame for accommodating backlight units stacked, a panel guide coupled to the support main frame, a main board for generating control signals and data for image display of the LCD, a TCP for performing data matching and synchronization between the main board and the display panel, and top and bottom casings coupled to each other to protect the elements, wherein the TCP board comprises high frequency attenuation means for conducting static electricity having high frequency components introduced through a hole for fastening the board to a ground terminal, filtering out specific part of the high frequency components of the static electricity, and attenuating the static electricity; a plurality of resistance means provided in the TCPB board to perform suppression when backflow of current occurs due to counter electromotive force of static electricity introduced through a data transmission path which interfaces with the main board; and resistance variation means located between an input terminal and a ground terminal of drive voltage applied through the main board, and configured to apply voltage to a ground when the voltage across the input terminal of the drive voltage becomes higher than a predetermined value due to static electricity.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the elements of a conventional LCD module;

FIG. 2 is a diagram illustrating an example of the performance of an ESD test;

FIG. 3 is a diagram illustrating an example of a conventional TCP board; and

FIG. 4 is a diagram illustrating the structure of a TCP board applied to the LCD module of the present invention.

### DESCRIPTION OF THE PREFERRED EMBODIMENTS

Reference now should be made to the drawings, in which the same reference numerals are used throughout the different drawings to designate the same or similar components.

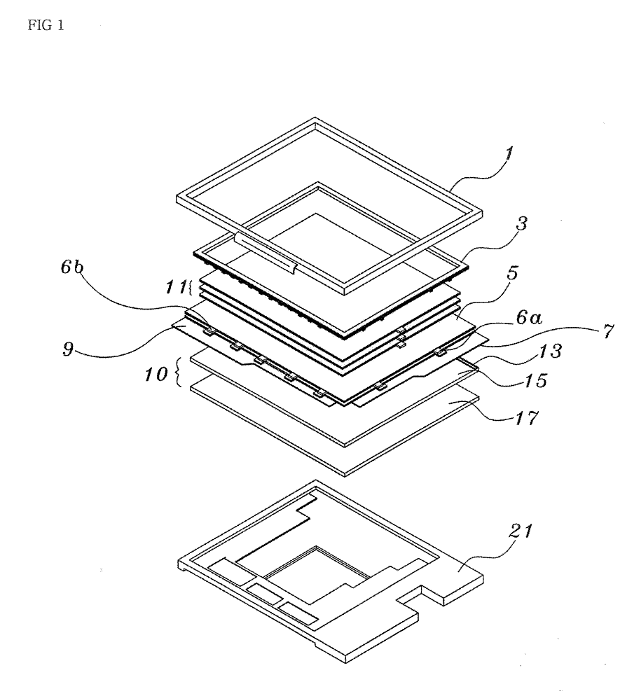

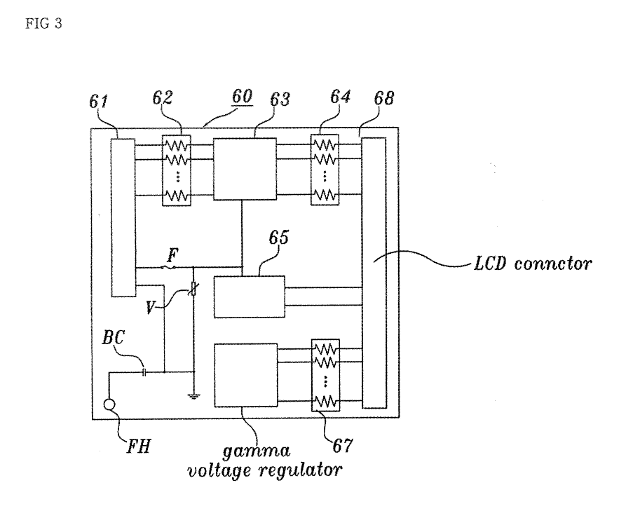

Before the technical concept applied to the present invention is described, the procedure in which static electricity is introduced into an LCD module and systematic errors occur due to the static electricity is described with reference to FIGS. 1 to 3. When there is no metal casing or copper shield for preventing static electricity, the static electricity is generally introduced into internal circuits through a panel guide 3. The element to which the static electricity is introduced first is a TCP board illustrated in the accompanying FIG. 3.

Since the panel guide 3 for fastening an LCD panel and a hole for fastening the TCP board illustrated in the accompanying FIG. 3 are coupled to each other by a single bolt, the static electricity introduced through the panel guide 3 is introduced into the TCP board through the fastening bolt. At this time, a metal pattern or metal patterns are formed on one or both surfaces of the TCP board, and elements are soldered on the upper portion of the metal pattern, so that a metal pattern having a certain area is also formed around the above-described hole for fastening the board so as to provide stability at the time of tightening the bolt.

It is apparent that the metal pattern around the hole for fastening the board does not contact the metal patterns within the TCP board, but, in view of the fact that the static electricity has characteristics of high-voltage noise and the electric metal patterns of the TCP board into which the static electricity is introduced are very close, the static electricity is substantially introduced into the electric metal circuit patterns of the TCP board though the metal pattern having the certain area around the hole for fastening the board.

Therefore, if the static electricity is introduced into the connections of a main board through the respective elements illustrated in FIG. 3, instantaneous high voltage is applied to the connected main board due to counter electromotive force even if a circuit is designed to be unidirectional, so that the connected main board is shut down or reset, or, at worst, damage to the main board occurs.

Therefore, if it is possible to drop the characteristic of the introduced static electricity from high voltage to low voltage, to convert instantaneous impact voltage into a signal having a predetermined time interval, and to conduct static electricity to a ground included in a circuit rather than en external ground, internal circuits can be protected from static electricity without use of the conventional metal casing or copper shield.

A preferred embodiment of the present invention is described below in detail with reference to the accompanying drawings.

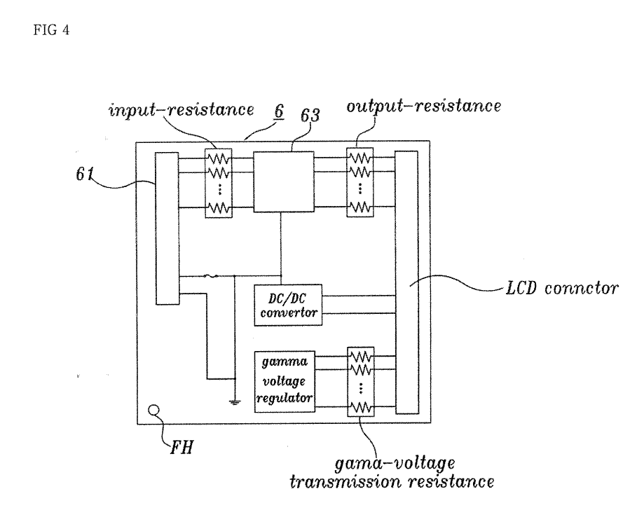

FIG. 4 is a diagram of an example of the construction of a TCP board which is applied to a liquid crystal display module according to the present invention. The TCP board includes a main board connection element 61 connected to a main board for transmitting image information and various control signals which are for overall control of the LCD module and driving the LDC panel, a fuse F provided with drive voltage introduced through the main board element 61, a timing control unit 63 driven by the voltage input through the fuse F and configured to receive data received through the main board connection element 61, synchronize and output it, first resistance elements 62, each providing a data transmission impedance between the main board connection element 61 and the timing control unit 63, a DC/DC converter 65 for receiving voltage input through the fuse F, performing voltage conversion and providing the drive voltage of the LCD panel, a gamma voltage unit 66 for receiving voltage input through the fuse F and generating voltage in response to a gamma signal, an LCD connection element 68 for providing signals output from the gamma voltage unit 66 and the timing control unit 63 and the drive voltage output from the DC/DC converter 65 to the LCD panel, second resistance elements 64, each providing a data transmission impedance between the timing control unit 63 and the LCD connection element 68, third resistance elements 67, each providing a data transmission impedance between the gamma voltage unit 66 and the LCD connection element 68, a varistor connected to one end of the fuse F and an ground and configured to drop voltage over a connection terminal with the fuse below a predetermined reference value when the voltage is larger than the predetermined reference value, and a Bead Core (BC) electrically connecting the metal pattern around the hole FH for fastening the board to a ground terminal within the board and configured to perform filtering and attenuation on a high-frequency signal induced in the metal pattern around the hole FH for fastening the board.

The procedure of performing a static-electricity resistance function in the TCP board 60 which is applied to the LCD module according to the present invention constructed as described above is described. Static electricity is introduced through the hole FH for fastening the board as described above.

In this case, the static electricity having high-frequency components introduced through the hole FH for fastening the board is first introduced to the ground terminal within the TCP board 60 through the BC.

As a result, some of the frequency components are filtered out and attenuated through the bead core BC. At this time, 600 Ω(ohm)/100 MHz is selected from a range of 100 to 1,000 Ω(ohm)/100 MHz as the impedance of the bead core BC.

Thereafter, although the static electricity is conducted to the ground terminal within the TCP board 60, voltage which is higher than a predetermined value is introduced through respective elements within the TCP board. In this case, a problematic one of the cases where the static electricity leaks to the outside through the TCP board 60 is the case where the static electricity flows through the main board connection element 61 due to counter electromotive force.

The reason for this is that, since voltage flowing through the LCD panel has a high frequency when static electricity leaks through the LCD connection element 68, a small amount of screen flickering occurs even if a large amount of static electricity is introduced. In contrast, when static electricity leaks through the main board connection element, the shutdown or reset of a system occurs and, at worst, damage to a main board is caused. Furthermore, in view of the characteristic of electric current, the static electricity introduced into the TCP board 60 may be introduced both through the main board connection element 61 and the LCD connection element 68, but, because the resistance of the LCD panel is high, more static electricity is introduced into the main board element 61.

The static electricity introduced into the main board connection element 61 is introduced into a power supply terminal connected to the first resistance elements 62 and the fuse F, so that, in the present invention, the varistor V is provided to the output terminal of the fuse F.

The vasistor V for 5V is used because the power supply voltage of the panel is 3.3 V. Therefore, if static electricity occurs, the resistance value of the varistor V dramatically decreases, and thus a great deal of counter electromotive force is eliminated.

Furthermore, conventionally, a resistance element having an impedance of 22 Ω(ohm) is used as each of the first resistance elements 62, but, in the present invention, a resistance element having an impedance of 100˜200 Ω(ohm) is used as each of the first resistance elements 62.

Therefore, the magnitude of voltage introduced into the main board due to the counter electromotive force decreases.

Data about the results of between a safety solution to static electricity according to the present invention, a conventional method and several experimental groups, is listed in the following table.

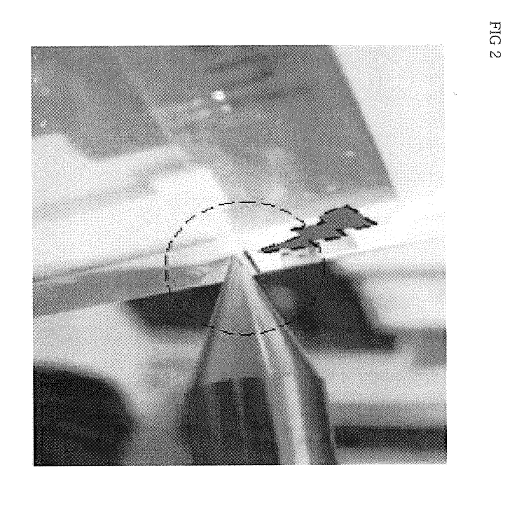

Furthermore, the test method at this time is identical to the method illustrated in FIG. 2, and the same amount of static electricity is repeatedly applied ten times.

| Test voltage of | Use of Copper | General | Increase of | Embodiment |
|---|---|---|---|---|
| static | foil + lead | LCD | TCP resistance | of present |
| electricity | line | module | value | invention |
| ±10 kv | ◯ | ◯ | ◯ | ◯ |
| ±20 kv | ◯ | X | ◯ | ◯ |
| ±24 kv | ◯ | X | X | ◯ |
| ±30 kv | ◯ | X | X | ◯ |
| Test results | Success | Fail | Fail | Success |

In the table, the general LCD module means an LCD module in which no anti-static method is used, or, in a copper shielding method, a copper foil and a lead line are eliminated. Furthermore, the increase of a TCP resistance value is a comparative example in the case where the input resistor of the conventional TCP board of FIG. 3 is replaced with a resistor having an impedance, the value of which is 330 Ω(ohm) within a range of 100˜500 Ω(ohm) as in the present invention.

As described above, there are advantages in that elements having high resistance to static electricity impact are used as circuit elements of a PCB inside a TCP connecting a front LCD panel to a rear main board, and static electricity introduced via the front LCD panel is dropped to a voltage that the main board can withstand when the static electricity is delivered to the main board, thereby having resistance to high voltage static electricity without requiring the formation or addition of a separate static electricity discharge path.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A Liquid Crystal Display (LCD) module including a display panel of an LCD, a support main frame for accommodating backlight units stacked, a panel guide coupled to the support main frame, a main board for generating control signals and data for image display of the LCD, a Taped Carrier Package (TCP Board) for performing data matching and synchronization between the main board and the display panel, and top and bottom casings coupled to each other to protect the elements, wherein the TCP board comprises:
high frequency attenuation means for conducting static electricity having high frequency components introduced through a hole for fastening the board to a ground terminal, filtering out specific part of the high frequency components of the static electricity, and attenuating the static electricity;
a plurality of resistance means provided in the TCP board to perform suppression when backflow of current occurs due to counter electromotive force of static electricity introduced through a data transmission path which interfaces with the main board; and
resistance variation means located between an input terminal and a ground terminal of drive voltage applied through the main board, and configured to apply voltage to a ground when the voltage across the input terminal of the drive voltage becomes higher than a predetermined value due to static electricity.

2. The LCD module as set forth in claim 1, wherein the high frequency attenuation means uses a bead core (BC).

3. The LCD module as set forth in claim 2, wherein the BC has a 100 to 1,000 Ω(ohm)/100 MHz specification.

4. The LCD module as set forth in claim 1, wherein the plurality of resistance means are connected to respective data transmission paths interfacing with the main board, and impedance of each resistance means is in a range from 100 to 500 Ω(ohm).

5. The LCD module as set forth in claim 1, wherein the resistance variation means is a varistor.

6. The LCD module as set forth in claim 5, wherein the varistor uses a critical voltage of 5V.
